(19) United States
(12) Patent Application Publication
(10) Pub. No.: US 2013/0241163 A1
(43) Pub. Date: Sep. 19, 2013

(54) Field harvest vehicle

(71) Applicant: James K. Bullis, Sunnyvale, CA (US)

(72) Inventor: James K. Bullis, Sunnyvale, CA (US)

(21) Appl. No.: 13/385,984

(22) Filed: Mar. 19, 2012

(51) Int. Cl. B60N 2/00

(52) U.S. Cl. 280/32.7

(57) ABSTRACT

Narrow harvest vehicles have been invented to make farm labor more attractive, to enable enhanced productivity of workers, and to make possible more complete usage of the land.

A low seating position is provided for a worker. The width of the vehicle is approximately the same width as the seated worker, enabling vehicle use with narrowly spaced row crops. The wheel set is configured for both maximum stability and efficient operation on soft surfaces, using large drum wheels that maximize the footprint area.

Apparatus is provided to enable gathering, collecting, and transporting produce in a manner consistent with operation in a narrow row space that avoids loading said vehicle in a destabilizing way and protects stacked produce from handling damage.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to agricultural vehicles.

2. Description of the Prior Art

There is on-going concern for future agricultural productivity, given the expanding world population. This concern is further exacerbated by the practice of using feed grain crops for making motor vehicle fuel. It is paramount that we make the best possible use of agricultural resources. One way to do this is to greatly expand irrigation by distributing water on a continental basis. This enlargement of agricultural operations could lead to a need for far more agricultural workers. Real progress could be based on a new kind of apparatus that would enhance productivity of workers and make the work into a more attractive activity. The right kind of new vehicles could also make possible a higher use of land, where the commonly allotted space for tractor passage through plantings could be reduced, thus even further improve usage of agricultural resources.

Some kinds of agricultural work are hard, slow, and uncomfortable. It is difficult to find workers and pay them enough to get them to do such tasks. To improve this situation with a machine requires both better productivity and greater comfort of the worker. Productivity has to be better per worker in order to make the cost of the machine affordable. Worker comfort has to be provided to attract worker, but also to enable more effective and sustained performance of tasks. Cost of the machine has to be compatible with expectations for improved productivity. Perhaps of greatest importance is the need for energy efficient operation. The intent is that the wages payable would ultimately increase. Worker safety must be carefully considered in developing new apparatus.

Compared with most generally familiar vehicles, agricultural vehicles of the sort that would significantly assist farm workers have significantly different performance requirements, and some of these offer potential for unique new system solutions. The biggest of these is the fact that for manual work, unusually low speed is desirable. Another key difference is that a low seat that would enable workers to reach to the ground would mean that conventional notions of how to stabilize a vehicle are inapplicable; particularly, a wide wheel base is not needed. Furthermore, the low operator riding position means that stability need not be so absolute since a roll over event would not be particularly hazardous; as we would normally think of such events for farm tractors. A design freedom is the fact that the overall length of a vehicle oriented toward row crop work can be quite large, enabling a vehicle and various ancillary equipment configured in a narrow but long train.

We look at the historical background for apparatus of this sort in the vast field of agricultural vehicles. Not much is found in the way of mechanization to realistically aid hand work in the fields. Rather, the tendency seems to be to develop tractor based solutions or tractor like systems. Tractors make it possible for some kinds of crops to automate the work and to provide very comfortable cab conditions. For some types of crops this leads to very successful operations utilizing ever larger tractors and harvesters of many types. However, the present need seems to call for different approaches. In many situations, especially harvest activities, the needed work can simply can not be done from a large vehicle because of the need for hand work close to the ground or for workers to be in positions relative to growing crops that would be awkward from large vehicles. Large vehicles are often not desirable because the crops themselves interfere with access by such vehicles, and unfortunately, this can lead to farming methods where crop spacing does not make the best possible use of land resources, simply because land must be reserved to allow for the vehicle to pass.

An example situation where the vehicle prevents crop spacing that would make the best use of land resources is shown in U.S. Pat. No. 3,546,856 Hiyama 1970, FIG. 2. Somewhat better, but still intrusive is the apparatus of U.S. Pat. No. 4,250,700 Horn et al. 1981. A farming system where it is desirable to enable both the worker and vehicle to pass under growing crop vines as illustrated by the U.S. Pat. No. 3,546,856 Hiyama 1970, FIG. 1 and U.S. Pat. No. 5,423,166 Scott 1995, thus showing the disadvantages of vehicles of the size range usually found in farm vehicles. Further, U.S. Pat. No. 5,423,166 Scott 1995 illustrates the intrusiveness of both grape acquisition machinery and the associated trailer by which harvested grapes are collected.

There are prior art vehicle configurations that have been invented with these purposes in mind. U.S. Pat. No. 3,589,744 Hansen 1971 illustrates an apparatus intended to function as an aid to workers. This seems well suited for row crop work. Though the invention U.S. Pat. No. 3,589,744 Hansen 1971 seems to be useful, it is complicated. Conventional wheels with balloon type tires mounted are arranged in a three point stabilizing form, generally like many farm tractors, but also harking back to the three wheeled Morgan roadster of long ago. This is adapted to working on low growing crops with over-arching structure that allows passing over crop rows, but all this leads to complicated equipment, when simplicity is needed to allow inexpensive construction. Still this invention by Hansen is successful in providing a low seat for a worker that enables low crop access, all the way to ground level. Hansen shows one wheel that is relatively large which would help hold down drag when traversing over soft earth, but this of course does not indicate an attempt to use this for stability.

A hard cylindrical wheel concept was disclosed in prior application U.S. Ser. No. 13/199,968 Bullis 2011 in connection with an off road vehicle system intended substantially for agricultural purposes. That invention included a wheel made of thin steel in the form of a hollow cylinder including end caps. Slats were laid on the outer cylinder surface for providing a tread and for strengthening the ground contact surface, and it was noted that these could be rubber coated.

That invention U.S. Ser. No. 13/199,968 Bullis 2011 has the purpose of enabling operation in a narrow row space between row crops where a low seated worker would have ready access to plantings by virtue of a low seat, that seat being adjustable in height as appropriate for the work.

U.S. Pat. No. 2,583,358 Cesan 1952 shows a garden tractor that also relates to these general objectives, though it utilizes conventional pneumatic tired wheels in a conventional four wheel arrangement. Some stability would be achieved due to the weight of the low seated worker, when that is the position of the seat, but the conventional tires would not provide the stability of the hard wheel of Ser. No. 13/199,968 Bullis 2011. Further, the stability that would be achieved under guidance of U.S. Pat. No. 2,583,358 Cesan is particularly called into question by the highly placed machinery, especially the engine shown. It appears that stability issues mean that the design of U.S. Pat. No. 2,583,358 is incapable of operating in the very narrow row space that is possible with U.S. Ser. No. 13/199,968 Bullis 2011. The explicitly stated function of straddling the row of plantings would derive from this limitation, instead of the otherwise operation entirely between rows of plantings.

The individual wheels of that U.S. Pat. No. 2,583,968 Cesan 1952 invention are narrow in width and relatively small in diameter, which means that they would have relatively small ground surface contact and would sink into dirt such that significant loss of energy would occur when moving. U.S. Ser. No. 13/199,968 Bullis 2011 particularly addresses this effect using the wide, large diameter, hard wheel system to spread load over the ground surface.

Continuous track vehicles serve to enable operation on soft dirt. A wide variation of such a track would offer lateral stability to prevent roll over, should it be used for that purpose, and the included wheels with the track could provide a wide wheel base if needed. The wide range of use of tracked vehicles in agriculture is represented by U.S. Pat. No. 1,376,649 Schneider 1921 and U.S. Pat. No. 4,683,969 Littau 1987. U.S. Pat. No. 7,543,664 Nelson 2009 shows a rubber version, and though this is not indicated, this could be adapted to provide stability as well as load spreading benefits. Generally, vehicles using tracked wheel systems arrange for the tracks to act in widely spaced pairs to provide stability. Rubber forms of tracked systems are used in snow-mobiles, where the single track contributes somewhat to vehicle stabilization.

Comparing again to U.S. Pat. No. 3,589,744 Hansen 1971, a simpler vehicle would be the recumbent bicycle as illustrated with a sidecar in U.S. Pat. No. 6,565,106 Lopez 2003. With or without a motor or engine this at least shows the basic simplicity needed. A tricycle form of this recumbent bicycle is an obvious variation that can be occasionally seen in use, but this would be still quite useless for the present purpose given that these wheels, though large in diameter, are narrow such that they would sink in soft dirt and cause much resistance to vehicle movement. The obvious tricycle form often includes wide, laterally spaced wheel sets; significantly wider than what would be desired for carrying a worker between narrowly spaced rows.

A very simple aid to workers would be the wheeled stool of U.S. Pat. No. 3,614,120 Cicero 1971 where a seat is provided with a seat back at a slanted position that would make low work more comfortable. This invention shows wide wheels but these are shown as they are mostly for convenience, as they are indicated to be typical rubber balloon tires. Stability for this “Chair Cycle” depends on the use of the legs and feet of the worker, not a lot differently from the way one legged milk stools were stabilized by the user. Though perhaps this is a useful apparatus, it can not be considered in the category of significant mechanization.

The impediment to progress of the widely used rubber, balloon, tractor tire such is indicated in U.S. Pat. No. 3,589,744 Hansen 1971. This works fine where there is a pair of widely spaced wheels that achieves stability, but by itself offers little resistance to rolling sidewise. But wide spacing is exactly what we are not looking for, in order to accomplish the present purposes for enabling more effective crop work.

Curiously, tractor tires of the 1920s utilized hard steel wheels with large spikes bolted to them, where these spikes were called lugs. Because the typical farmer used regular roadways to get tractors from field to field, these lugs caused much disruption of smooth road surfaces. All this went away with inflated rubber tires of the mentioned balloon type. Lugs might not matter to stability, and they could be advantageous in a low speed vehicle.

Searching for solid wheels that would improve stability with a narrow wheelbase turned up U.S. Pat. No. 1,210,056 Fairman 1916 where a narrow vehicle is fitted with hard wheels. This vehicle is questionable as to safety given the high seat position, and of course this configuration does not suggest any interest in enabling hand work on low crops. A tractor utilizing hard wheels configured of lateral slats overlaid with slanted gripping ridges is shown in U.S. Pat. No. 2,560,384 Crain 1951. Though far from the field of farm vehicles, a relevant solid drum wheel is shown in the baby carriage for use in soft dirt of U.S. Pat. No. 5,158,319 Norcia et al. 1992, though there is no low seat for farm work and no special stabilizing purpose involved other than that of conventional baby carriage wheels.

U.S. Pat. No. 6,752,228 Aoyama 2004 reminds us of a function of agricultural vehicles depending on existence of tow bar capabilities, but it also illustrates the difficulty that is encountered in making the seat position truly low. This particular invention is announced as one that enables a low profile operation.

The previously mentioned invention U.S. Pat. No. 2,583,358 Cesan 1952 is pertinent in that it is a form that enables work by a low seated worker. It is configured to enable the vehicle to straddle a row of plantings such that a worker could reach down between low, side rails and tend such plantings. Though U.S. Pat. No. 2,583,358 Cesan enables access directly in front and below the worker, the side rails that would interfere with work to the side at low heights.

Previously mentioned, pending application U.S. Ser. No. 13/199/968 Bullis 2011, is a narrow vehicle suited for operation in a single row space of a row crop field. Another pending application is a different configuration that enables unimpeded access to plantings.

None of the prior art answers the question of how harvesting could be accomplished consistent with the objectives of a narrow machine capable of operating in the constraint of a single row space.

### SUMMARY OF THE INVENTION

A harvest vehicle to make hand work in fields of row crops more attractive and effective is configured as a narrow apparatus that operates in a narrow row space between plants. It enables close access to crops by a worker who would sit generally facing forward in a seat that is capable of being set close to ground level, where the worker would carry out the sensitive tasks of produce gathering. He would also collect and transport a substantial amount of such produce while thus seated. The overall harvest activity would be confined within the same narrow row space traditionally required for a completely manual activity.

The unusually narrow vehicle is stabilized by a front and a rear wheel set that maximizes vehicle stance in combination with a distribution of weight that results in a low center of gravity. The configuration enables gathering, collecting, and transporting of produce without disturbing plants on either side, while maintaining the stable weight distribution throughout the operation.

Produce is protected from handling damage, where a tray system is fed by a chute arrangement and the tray system is adjusted in height as produce is accumulated. Trays are sequentially loaded by sliding respective containers onto trays, where a tray is held at the level of a transfer chute and a container is slid on that chute onto that tray. After each successive loading operation that tray is lowered on vertical rails and a next tray is positioned for loading. Prior to being loaded, the empty trays are held above the loading level on the rails. This arrangement results in a full total load that has the lowest possible center of gravity. Before loading, there is a highly placed stack of empty trays that represents a light weight that does not cause vehicle instability.

The preferred loading apparatus is attached ahead of the forward vehicle wheel such that the worker can easily pack containers, load them onto trays, and control the vertical position of the rack of trays, though expanded capacity arrangements are possible and flexible usage would involve variations involving containers and trays.

### BRIEF DESCRIPTION OF THE DRAWINGS

FIG. 1 Narrow harvest vehicle for work in a field of row crops, where apparatus is in fully loaded condition

FIG. 2 Narrow harvest vehicle with harvest apparatus in configuration prior to loading containers onto rack of shelves

FIG. 3 Harvest apparatus enabling boxes to be stacked on rack without use of shelves

FIG. 4 Harvest apparatus enabling produce to be loaded on shelves in rack without containers

FIG. 5 Harvest apparatus for open loading of open container for reduced bruising of produce

FIG. 6 Example of vehicle extension involving multiples of harvest apparatus

### DETAILED DESCRIPTION

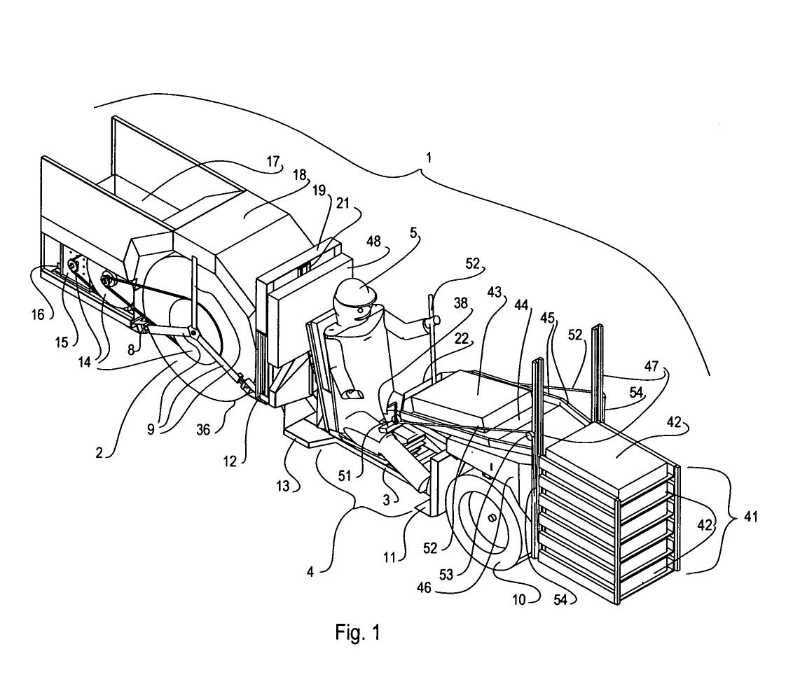

Mechanization to aid field workers is shown in FIG. 1. It is a narrow harvest vehicle for use in a single row space of a row crop field. The configuration is a light weight, efficient, and low cost vehicle. The vehicle 1 utilizes a wide rigid wheel system 2 that provides maximum stability and causes a minimum of energy loss due to earth depression. Front 10 and rear wheel 2 wheel systems are connected by a low and narrow tongue structure 3 over which is generally seated a worker represented by place holder 5. The tongue 3 is shaped to enable a convenient approach to low plant and ground levels through ground access 4. Structure interfacing of the tongue 3 with the rear frame includes a brace 13 which is useful for imparting turning force to the wide rear wheel system 2. Turning force on the rear wheel 2 is not insignificant due to its solid and wide surface contact and significant concentration of vehicle weight on this rear wheel 2 through the use of the arch structure 18 and weight bearing strap system 9.

Vehicle parts include a direction controlling wheel set 10 that carries produce load, where closely spaced wheels provide some spreading of that load over the ground surface. These can be rubber or hard cylinders, and though hard cylinders are preferred for stability practicality suggests use of readily available rubber tires. Front wheels are mounted on pivoting apparatus that provides a vertical pivot axis for each, and in this configuration, this axis is positioned to minimize forces that could cause steering annoyances. The knee controlled tiller 38 operates through tiller pivot bearing 23 to control these pivot mounted 24 front wheels through control rods 25. This control functions under the work tray 22 provided for worker use.

Further details include a foot rest 11, seat positioning rollers (available as ‘heavy duty skate wheels’ from McMaster-Carr industrial supply) on the side 12 and center 21 which enable change of seat height, these operating on rails mounted on wall 12 which is attached to the arch structure 18. A truck space is provided 17 with battery space underneath such that batteries are carried on the lowest level of the rear of the vehicle. Trailer attachment 16 is indicated An access panel is off, to show how drive force is generated with the DC electric motor 15 (Mars P/N ME0709) which drives a chain and sprocket (also from McMaster Carr as standard roller chain and sprockets) gearing system 14 which drives the large wheel 2. The motor control is by simple incremental electrical switching, though continuous variable speed control is known in the industry. The large wheel 2 is specially formed to provide the benefits of a large wheel without the usual weight of such. Thus, it is a drum formed of sheet metal, provided with bearings and held with straps 9 that carry weight but do little to keep the wheel 2 from moving laterally. However, lateral stabilizing roller 8 and its opposite side counterpart are placed as shown to keep proper alignment of this light weight drum system. Safety side panels would enclose the wheel and chain drive equipment, though such panels are removed here for clarity.

A sun shade panel is not shown, but is an obvious part of a system that is intended to make farm work attractive.

The previous invention, U.S. Ser. No. 13/199,968 Bullis 2011, disclosed slats that have a rubber surface being attached to the drum to provide strength at the surface and a slightly soft ground contract surface. Track pads from the heavy track vehicle industry are being utilized as the slats 36; these having been acquired from McLaren Industries, as part Hybrid Rubber Shoes 350 MM. The fact of generally low center of gravity, low operating speed makes it possible that the wide and firm drum wheel system 2 provides the needed stability. And of course, the large area footprint of such a wheel system 2 means the whole vehicle will operate much more efficiently than vehicles with wheels having a smaller footprint.

Light weight structures are achieved with the use of triangular and trapezoidal panel shapes made of 16 gauge sheet metal, with 11 gauge sheet metal at points of stress concentration. This construction has demonstrated the validity of the small tongue connecting structure as shown. Thus, the wall 19 structure, the arch 18 structure and the rear compartments are configured to transfer the more significant loads to the large wheel 2 axle, while meeting a light weight objective

To achieve the narrow vehicle objectives in a harvest operation, the overall vehicle remains approximately the same width as the seated worker, thus continuing the definition of width applicable to the core vehicle.

To cut, gather, package, hold, and transport produce without disturbing plantings on either side by the apparatus or by the worker walking to carry out loading activities, special equipment is needed. The particular requirement is to enable the worker to move produce into protective stacking equipment in such a way that stability of the narrow vehicle is not seriously degraded and produce is protected against crushing load of stacked produce.

Continuing with FIG. 1, observe a fully loaded vehicle utilizing a rack of trays 41, where the trays are sequentially loaded by sliding respective containers 43,42 onto the trays 41. The rack holds a next tray at the level of a transfer chute 44 and a container 43,42 is slid on that chute 44 onto that tray with the aid of push stick 48. The chute 44 provides guidance rails 45 that guide containers 43,42 being slid into position on the tray. After each successive loading operation that tray is lowered on vertical rails 47 and a next tray is positioned for loading using a winch 51, control ropes 52,54. Containers 43,42 may be unable to protect produce from above and may not be stackable without trays 41.

The chute 44 is configured for the produce involved, and is simply a sliding surface in its simplest form. That chute 44 is capable of being moved, directed, tilted, or manipulated in whatever manner desired. Devices such as conveyor belts are appropriate in some applications. The worker takes flattened container from holding box 48 and assembles it as a useable produce container 43 on the loading chute 44.

The vertical rails 47 are structurally attached to the vehicle structure that arches over the front wheels 10. The rack of trays 41 is then carried as low as possible to an unloading station. Then it is prepared to collect a new load.

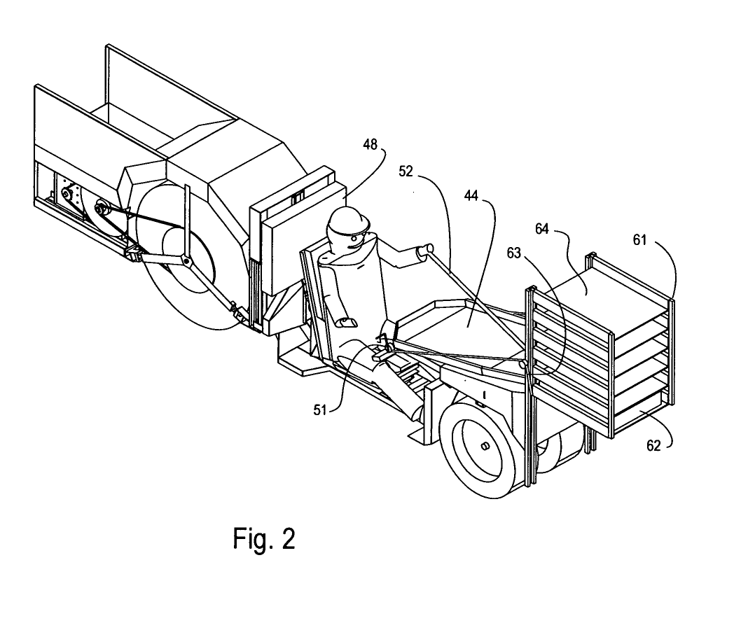

FIG. 2 shows the apparatus, ready for that new load, where the empty trays are held above the loading level on the vertical rails 47. The winch 51 enables the worker to raise the rack of empty trays to the height shown. Thus, in the empty state there is a highly placed stack of empty, light weight trays that does not unduly raise the center of gravity. When fully loaded, the heavy loaded rack is low so the center of gravity is as low as possible. As shown, collapsed containers are in rear box 48 and loading tray and chute 44 are empty. The top empty shelf surface 64 will be the last shelf to be loaded of the rack of trays or shelves. In the illustration, one container 62 has been placed on the lowest rack tray.

The tray system 41 provides protection from crushing that functions in addition to the protection provided by cardboard boxes that are the said containers. At a secondary loading point, the containers would likely be taken from the rack shelves and loaded on pallets for bulk shipping on larger vehicles.

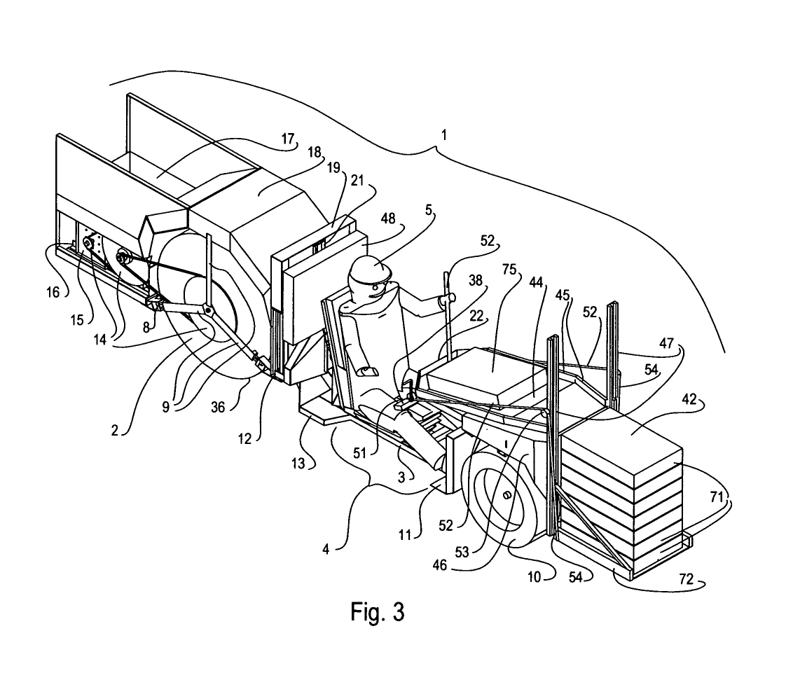

FIG. 3 shows the apparatus operation with containers that are configured to stack and adequately provide support without the trays. In this simplified system, a base rack tray 72 acts to support a stack of such containers 71. This base rack 72 is lowered to enable successive containers to be slid onto the top of the stack. Control ropes raise and lower the rack 72 as before, through the action of the worker enabled by the winch 51.

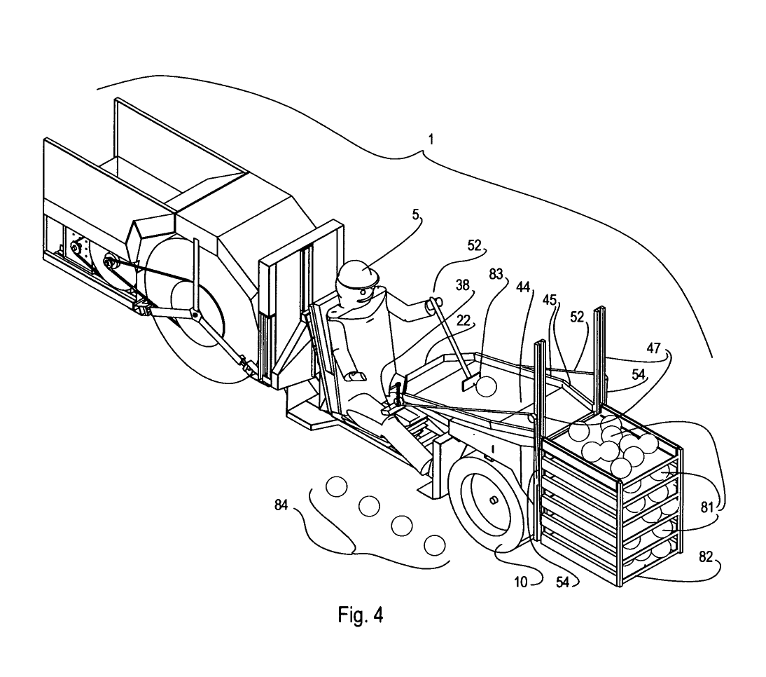

Another variation involves use of the rack of trays without containers, where it is convenient to handle produce in this way, and the produce has sufficient structural form to be self protecting against crushing. In FIG. 4 the harvest process is illustrated, where produce 84 is to be collected, produce 83 on the loading chute has been collected, and produce 81 has been pushed onto shelves 82 using pusher 52.

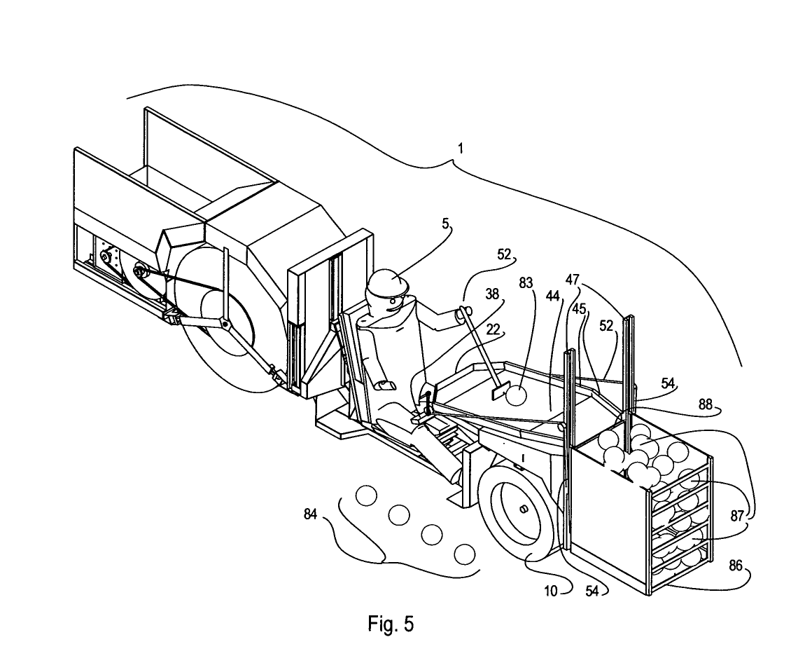

FIG. 5 shows a further variation that includes use of a single tray at the bottom 86, and here without separating shelves or containers, the produce is continually stacked on previously collected produce. In this example, the invented stacking system functions to ease impact of adding additional produce as it is loaded on that produce as well as impact on previously loaded produce. There is a barrier panel 88 over which produce 87 passes as it goes into the basket. The basket is regularly adjusted to a lower position as loading goes on.

A worker, or workers, would remain in a generally seated work position as a result of this apparatus, and they would not be required to walk on or among plantings to carry out loading activities.

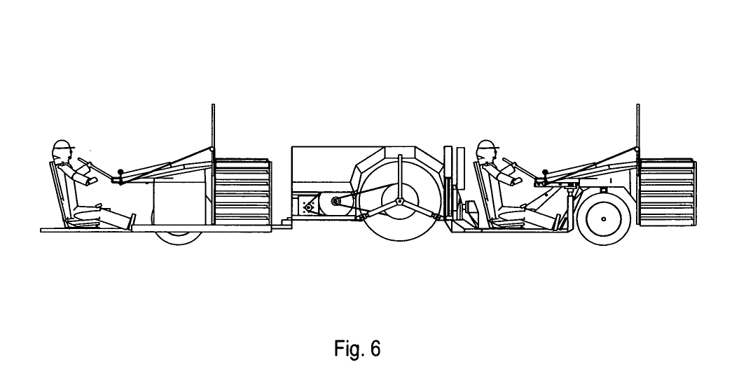

This loading apparatus shown is attached ahead of the forward vehicle wheel such that the worker can easily pack containers, load them onto trays, and control the vertical position of the rack of trays. However, variations are anticipated that also enable operations in a single row space. These could involve wheel supported extensions of the vehicle that hold such racks, whether they lead or follow the core vehicle and regardless of the method of maintaining a connecting chute or controlling rolling direction of the wheel or wheels. Extension of the apparatus could also involve multiple workers and associated variations of the core vehicle. FIG. 6 illustrates one possible such extension, where a rear trailer is a basis for a second collecting, loading, and transporting activity.

For prototype implementation of machinery functions, extensive use has been made of inexpensive spindles and hubs from the highway trailer vehicle world. This minimized cost while incurring a minor penalty of minimizing weight. There are, of course, many variations of the here described invention that one familiar with machine design would readily utilize. It is also expected that mass production would lead to significant design variations to enable effective production methods.

The use of an electric motor and batteries is particularly attractive, though addition of an auxiliary engine is anticipated in many cases, and even a fully mechanical drive system has its uses in some applications.

The scope of the invention is to be defined by the appended claims.

I claim:

1. A narrow harvest vehicle that includes a frame, an attached set of wheels, an attached seat for a farm worker, and apparatus to collect and transport produce, where said narrow harvest vehicle is of a width that substantially occupies a single row space between rows of plants, where said seat enables said worker to gather produce, and where said apparatus to collect and transport produce enables said produce, so gathered, to be placed in containers and loaded into a stacking mechanism, where said stacking mechanism operates such that a center of gravity of loaded produce is lowered with the addition of each successive container, and where loading of produce into said stacking mechanism is enabled without intrusion outside said single row space.

2. A narrow harvest vehicle according to claim 1, where said single row space has width that is approximately that required for un-mechanized harvest labor.

3. A narrow vehicle according to claim 1, where said narrow vehicle is approximately equal in width to a seated said farm worker.

4. A narrow vehicle according to claim 1, where said narrow vehicle is approximately equal in width to a seated and forward facing said farm worker.

5. A narrow vehicle according to claim 1, where said stacking mechanism provides protection of said containers.

6. A narrow vehicle according to claim 1, where said apparatus to collect produce enables effective transport of said produce to a successive loading place.

7. A narrow harvest vehicle according to claim 1, where said attached set of wheels includes wheels located at more than two longitudinal positions.

8. A narrow harvest vehicle according to claim 1, where operation is enabled whereby said intrusion is not into space beyond that necessary for passage of said narrow vehicle.

9. A narrow harvest vehicle according to claim 1 that enables said seat to be set close to ground level.

10. A narrow harvest vehicle according to claim 1 where said containers are open containers.

11. A narrow harvest vehicle according to claim 1 that includes harvest apparatus that is attached as a trailer to a towing vehicle.

12. A narrow vehicle for agricultural work that includes a frame with an attached set of wheels, an attached seat for a farm worker, and apparatus to collect produce, where said narrow vehicle is of a width that substantially occupies a single row space between plantings, where said seat enables said worker to gather produce, and where said apparatus to collect produce enables produce, so gathered, to be loaded as successive collected increments into a stacking mechanism, where a center of gravity of loaded produce is lowered with the addition of each successive collected increment, and where loading of produce into said stacking mechanism is enabled without intrusion outside said single row space.

13. A narrow vehicle according to claim 12, where said narrow vehicle is approximately equal in width to a seated said farm worker.

14. A narrow vehicle according to claim 12, where said narrow vehicle is approximately equal in width to a seated and forward facing said farm worker.

15. A narrow vehicle according to claim 12, where said stacking mechanism provides protection of said collected increments such that crushing force of an upper increment does not bear on a lower increment.

16. A narrow vehicle according to claim 12, where said apparatus to collect produce enables effective transport of said produce to a successive loading place.

17. A narrow vehicle according to claim 12, where said apparatus to collect produce is supported on a ground surface by a wheel that is not mounted on said narrow vehicle.

18. A narrow vehicle according to claim 12, where operation is enabled such that said intrusion is not into space beyond that necessary for passage of said narrow vehicle.

19. A narrow harvest that includes a frame with an attached set of wheels, an attached seat for a farm worker, and apparatus to collect produce, where said narrow vehicle is of a width that substantially occupies a single row space between plantings, where said seat enables said worker to gather produce, and where said apparatus to collect produce enables produce, so gathered, to be loaded as acquired into a stacking mechanism, where a center of gravity of loaded produce is lowered with each addition of said produce, and where loading of said produce into said stacking mechanism is enabled without intrusion outside said single row space.

20. A narrow harvest vehicle according to claim 19, where said stacking mechanism eases impact on produce relative to that where said produce is simply dropped into a container.
